(19) United States
(12) Patent Application Publication
(10) Pub. No.: US 2017/0109101 A1
(43) Pub. Date: Apr. 20, 2017

(54) SYSTEM AND METHOD FOR INITIATING STORAGE DEVICE TASKS BASED UPON INFORMATION FROM THE MEMORY CHANNEL INTERCONNECT

(71) Applicant: SAMSUNG ELECTRONICS CO., LTD., Suwon-si (KR)

(72) Inventors: Craig HANSON, San Jose, CA (US); Michael BEKERMAN, Los Gatos, CA (US); Siamack HAGHIGHI, Sunnyvale, CA (US); Chihjen CHANG, Fremont, CA (US)

(21) Appl. No.: 14/970,008

(22) Filed: Dec. 15, 2015

Related U.S. Application Data
(60) Provisional application No. 62/242,924, filed on Oct. 16, 2015.

(51) Int. Cl. G06F 3/06

(52) U.S. Cl. CPC G06F 3/0679; G06F 3/0608; G06F 3/0616; G06F 3/0652; G06F 3/0659

(57) ABSTRACT

A memory module includes a solid-state drive (SSD) and a memory controller. The memory controller receives information from a host memory controller via a synchronous memory channel and determines to initiate background tasks of the SSD based on memory commands and a state of the memory module. According to one embodiment, the synchronous memory channel is a DRAM memory channel, and the SSD includes a flash memory. The background tasks of the SSD such as garbage collection, wear leveling, and erase block preparation are initiated during an idle state of the memory module.

### CROSS-REFERENCE TO RELATED APPLICATION(S)

This application claims the benefit of and priority to U.S. Provisional Patent Application Ser. No. 62/242,924 filed Oct. 16, 2015, the disclosure of which is incorporated herein by reference in its entirety.

### TECHNICAL FIELD

The present disclosure relates generally to memory systems for computers and, more particularly, to a system and method for performing background tasks of a solid-state drive (SSD) based on information on a synchronous memory channel.

### BACKGROUND

A solid-state drive (SSD) stores data in a non-rotating storage medium such as dynamic random-access memory (DRAM) and flash memory. DRAMs are fast, have a low latency and high endurance to repetitive read/write cycles. Flash memories are typically cheaper, do not require refreshes, and consumes less power. Due to their distinct characteristics, DRAMs are typically used to store operating instructions and transitional data, whereas flash memories are used for storing application and user data.

DRAM and flash memory may be used together in various computing environments. For example, datacenters require a high capacity, high performance, low power, and low cost memory solution. Today's memory solutions for datacenters are primarily based on DRAMs. DRAMs provide high performance, but flash memories are denser, consume less power, and cheaper than DRAMs.

Scheduling background tasks for an SSD is difficult to optimize because the SSD device is an endpoint device, and the non-volatile memory controller of the SSD has no knowledge of forthcoming activities. Further, a memory bus protocol between a host computer and the SSD does not indicate a particularly good time to schedule background tasks such as wear leveling and garbage collection of the SSD. SSD devices are traditionally connected to input/output (I/O) interfaces such as Serial AT Attachment (SATA), Serial Attached SCSI (SAS), and Peripheral Component Interconnect Express (PCIE). Such I/O interfaces neither indicate particularly good times to schedule background tasks.

### SUMMARY

A memory module includes a solid-state drive (SSD) and a memory controller. The memory controller receives information from a host memory controller via a synchronous memory channel and determines to initiate background tasks of the SSD. According to one embodiment, the synchronous memory channel is a DRAM memory channel, and the SSD includes a flash memory. The background tasks of the SSD such as garbage collection, wear leveling, and erase block preparation are performed during an idle state of the memory module.

According to one embodiment, a method includes: receiving memory commands from a host memory controller via a synchronous memory channel; determining a device state of a memory module including a solid-state drive (SSD) based on the memory commands; and initiating background tasks of the SSD based on the device state.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 shows an architecture of an example memory module, according to one embodiment;

FIG. 2 is an example flowchart for performing overhead activities for an SSD, according to one embodiment;

FIG. 3 shows an example for initiating background tasks based on an inactivity timer, according to one embodiment;

FIG. 4 shows an example for initiating SSD background tasks based on a programmable threshold of refreshes, according to one embodiment;

FIG. 5 shows an example for initiating SSD background tasks based on a power-down entry command, according to one embodiment; and

FIG. 6 shows an example for initiating SSD background tasks based on a self-refresh entry command, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

The memory controller receives information from a host memory controller via a synchronous memory channel and determines to initiate background tasks of the SSD based on memory commands and by maintaining knowledge of a state of the memory module. The memory commands herein may refer to commands to standard DRAM memories defined by Joint Electron Device Engineering Council (JEDEC). The present memory module may not be a standard DRM memory including a flash memory, and the host memory controller may not distinguish the present memory module from standard DRAMs. According to one embodiment, the synchronous memory channel is a DRAM memory channel, and the SSD includes a flash memory. The background tasks of the SSD such as garbage collection, wear leveling, and erase block preparation are performed during a presumed idle state of the memory module.

Each of the features and teachings disclosed herein can be utilized separately or in conjunction with other features and teachings to provide a system and method for performing background tasks of a solid-state drive (SSD) based on information on a synchronous memory channel. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present disclosure provides a memory system and method for utilizing DRAM power mode and refresh commands in conjunction with a DRAM device state to initiate background related tasks for an SSD. The present system and method can optimize the operation of the SSD to achieve increased efficiency and improved performance. The background tasks can take substantial amounts of time, and prevent the use of certain flash resources (reducing performance). Thus, scheduling these background tasks during an idle I/O period improves operational effectiveness. The background tasks for the SSD can include, but are not limited to, garbage collection, wear leveling, and erase block preparation. Wear leveling generally refers to a technique for prolonging a service life of a flash memory. For example, a flash memory controller arranges data stored in the flash memory so that erasures and re-writes are distributed across the storage medium of the flash memory. In this way, no single erase block prematurely fails due to a high concentration of write cycles. There are various wear leveling mechanisms used in flash memory systems, each with varying levels of flash memory longevity enhancement. Garbage collection refers to a process for erasing garbage blocks with invalid and/or stale data of a flash memory for conversion into a writable state.

The background tasks may be automatically initiated in a power-down mode, a self-refresh, or an auto-refresh mode of the SSD. The SSD background tasks can capitalize on dynamic optimization metrics based upon a workload and a current state of the memory system.

Herein, the present system and method is generally described with reference to a memory channel storage device with DRAM and flash components. However, other types of memory, storage, and protocols are equally applicable without deviating from the scope of the present disclosure. Examples of applicable types of memory include, but are not limited to, synchronous DRAM (SDRAM), single data rate (SDR) SDRAM, double data rate (DDR) SDRAM (e.g., DDR, DDR1, DDR2, DDR3, and DDR4), a flash memory, a phase-change memory (PCM), a spin-transfer torque magnetic RAM (STT-MRAM), and the like. The Joint Electron Device Engineering Council (JEDEC) Solid State Technology Association specifies the standards for DDR SDRAMs and definitions of the signaling protocol for the exchange of data between a memory controller and a DDR SDRAM. The present system and method may utilize the signaling protocol for the exchange of data defined by JEDEC as well as other standard signaling protocols for other modes of data exchange. The memory module can include one or more SSDs coupled to a DRAM memory channel on a host computer system.

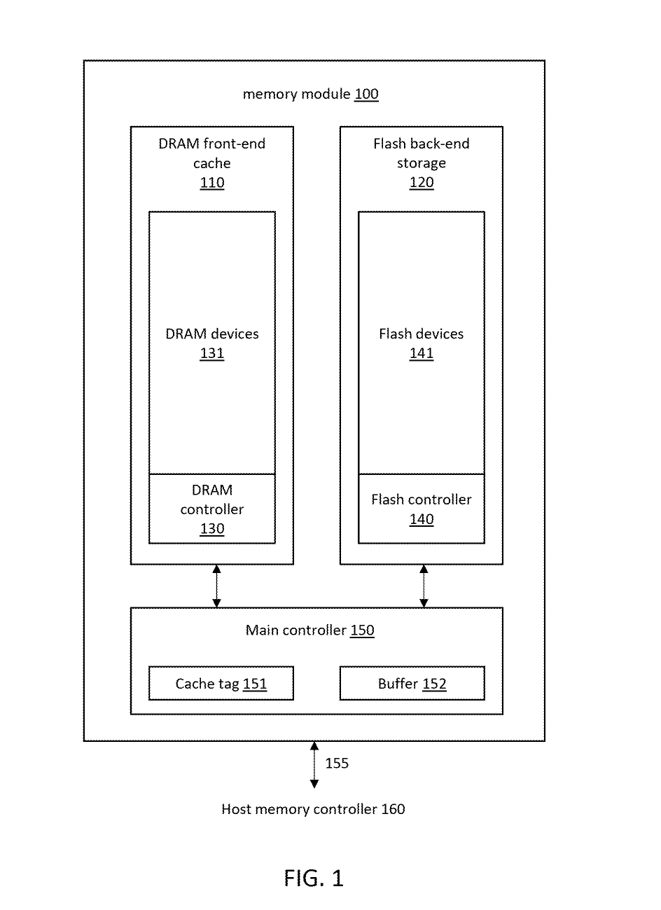

FIG. 1 shows an architecture of an example memory module, according to one embodiment. A memory module 100 can include a front-end DRAM cache 110, a back-end flash storage 120, and a main controller 150. The front-end DRAM cache 110 can include one or more DRAM devices 131. The back-end flash storage 120 can include one or more flash devices 141. The main controller 150 can interface with a DRAM controller 130 configured to control the DRAM cache 110 and a flash controller 140 configured to control the flash storage 120. The memory module 100 can interface with a host memory controller 160 via a DRAM memory channel 155.

The main controller 150 can contain a cache tag 151 and a buffer 152 for temporary storage of the cache. The main controller 150 is responsible for cache management and flow control. The DRAM controller 130 can manage memory transactions and command scheduling of the DRAM devices 131 including DRAM maintenance activities such as memory refresh. The flash controller 140 can be a solid-state drive (SSD) controller for the flash devices 141 and manage address translation, garbage collection, wear leveling, and schedule tasks.

Via the DRAM memory channel 155, the host computer 160 provides memory commands to the memory module 100. The memory commands can include traditional DRAM commands such as power and self-refresh commands. Using the memory commands received via the DRAM memory channel as an indication of the status of the memory module 100, the main controller 150 can optimize the performance and device wear characteristics for the flash devices 141. In one embodiment, the main controller 150 can schedule device-internal maintenance functions such as garbage collection, wear leveling, and erase block preparation. In another embodiment, the flash controller 140 can schedule device-internal maintenance functions.

According to one embodiment, memory commands received via the DRAM memory channel 155 include a power-down command, a power-savings mode command, and a self-refresh command, amongst others. These commands can indicate the main controller 150 to perform device-internal maintenance functions and invoke flash-specific overhead-related procedures for the flash devices 141.

When the main controller 150 detects a period of inactivity based on the memory commands received via the DRAM memory channel 155, the main controller 150 or the flash controller 140 can perform various flash-specific overhead activities. Even if new DRAM bus activity resumes prior to the completion of previously initiated SSD background tasks, the memory commands received from the DRAM memory channel 155 can be useful indicators of a potential period of inactivity that can be utilized to perform background tasks of the SSD.

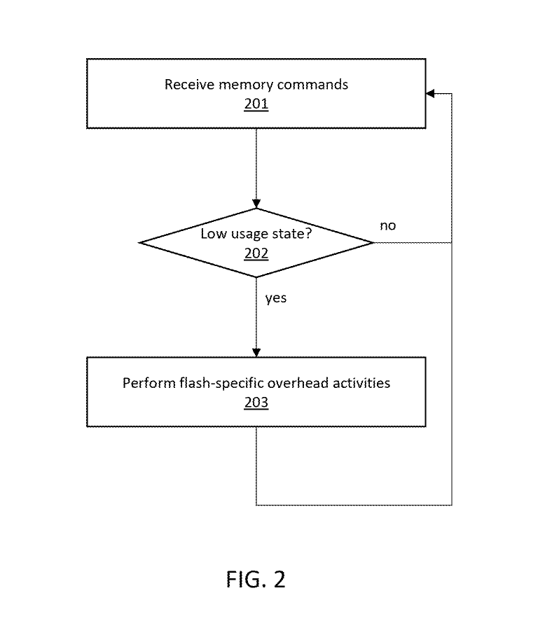

FIG. 2 is an example flowchart for performing overhead activities for an SSD, according to one embodiment. Referring to FIGS. 1 and 2, the memory controller 150 receives memory commands from the host computer 160 via the DRAM memory channel 155 (step 201). Based on the memory commands, the memory controller 150 can determine that the memory module 100 will enter into low usage state (step 202). For example, the memory controller 150 determines a period of inactivity or low usage based on the absence of memory commands on the DRAM memory channel 155, or based on the receipt of a memory command indicating a future period of inactivity, such as a low-power state command. When the memory controller 150 determines that there is no immediate activities or tasks to perform on the memory module 100, for example, memory reads or writes, the memory controller 150 can instruct the flash controller 140 to perform flash-specific overhead activities (step 203). It is noted that the memory controller 150 can receive memory commands via the DRAM memory channel 155 as normal, and is normally ready to perform the received memory commands. If DRAM commands are received by the memory controller 150 in step 201, the DRAM inactivity state is determined continuously and either continues to allow the initiation of SSD background tasks, or returns back to a SSD performance mode that deprioritize initiation of SSD background tasks.

According to one embodiment, the memory module 100 can accept one or more memory commands per clock cycle. The data bus size of the DRAM memory channel 155 may vary depending on the memory system and the manufacturer of the memory chips of the memory module 100. For example, the present memory module 100 can be a 168-pin dual in-line memory module (DIMM) that reads or writes 64 bits (non-ECC) or 72 bits (ECC) at a time.

The memory control signals sent from the host memory controller 160 to the memory module 100 can indicate various memory operation commands. Examples of memory control signals include, clock enable (CKE or CE), chip select (CS), data mask (DQM), row address strobe (RAS), column access strobe (CAS), and write enable (WE). The memory commands can be timed relative to a rising edge of the clock enable signal CKE. When the clock enable signal CKE is low, the main controller 150 of the memory module 100 ignores the following memory commands and merely checks whether the clock enable signal CKE becomes high. The main controller 150 resumes normal memory operations on a rising edge of the clock enable signal CKE.

According to one embodiment, the main controller 150 of the memory module 100 uses the clock enable signal CKE to initiate flash-specific overhead activities. The main controller 150 can sample the clock enable signal CKE each rising edge of the clock and trigger the flash controller 140 to perform flash-specific overhead activities after detecting that the clock enable signal CKE is low.

If the main controller 150 determines that the memory module 100 is in an idle state, for example, all banks of the memory module 100 are precharged and no memory commands are in progress, the memory module 100 can enter a power-down mode if instructed by the host memory controller. According to one embodiment, the memory controller 150 can perform the flash-specific overhead activities in the power-down mode.

If the clock enable signal CKE is lowered at the same time as an auto-refresh command is sent to the memory module 100, the memory module 100 can enter a self-refresh mode. In the self-refresh mode, the main controller can generate internal refresh cycles using a refresh timer. According to one embodiment, the memory controller 150 can perform the flash-specific overhead activities in the self-refresh mode.

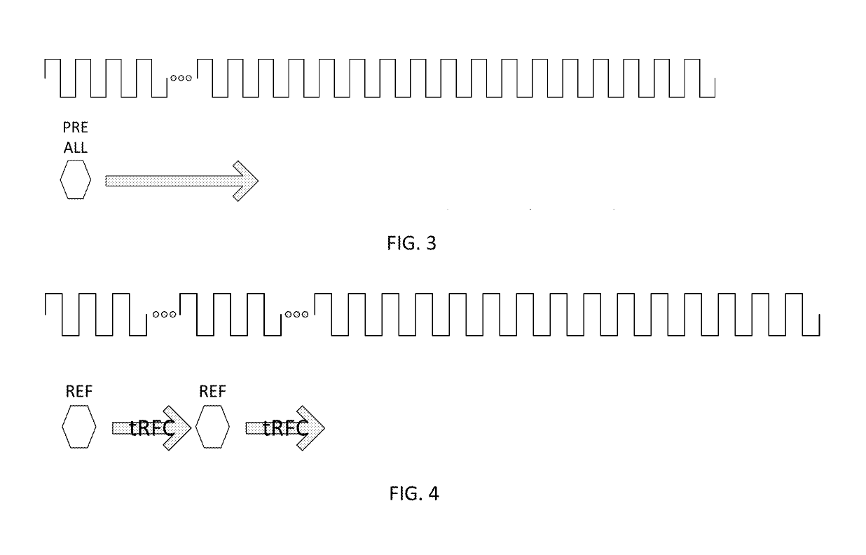

FIG. 3 shows an example for initiating background tasks based on an inactivity timer, according to one embodiment. When the main controller 150 detects that all memory banks are precharged (i.e., all banks precharged), the main controller 150 can determine that the memory module 100 can enter into an idle state and start the inactivity timer indicating inactivity using a programmable counter. In another embodiment, the host controller 160 can send a precharge all command to the main controller 150, and the main controller 150 can start the inactivity timer. The inactivity timer can signal that all banks of the memory module 100 are idle.

When the inactivity timer indicates that a predefined programmable threshold duration has elapsed, and no further memory commands have been received, i.e., the memory module 100 has been in an idle state sufficiently long, the main controller 150 can trigger the flash controller 140 to perform background tasks of the flash devices 141. In this case, the host memory controller 160 may not enter a power-down mode or a self-refresh mode. The threshold duration of the inactivity timer is programmable, and can change based on a user setting.

According to one embodiment, a programmable number of refresh commands received by the memory module 100 can initiate background SSD operations. FIG. 4 shows an example for initiating SSD background tasks based on a programmable threshold of refresh commands, according to one embodiment. DDR4 allows refresh commands to be issued in advance indicating that a memory controller is getting ahead on the refresh commands while they are not handling write/read traffic. After a refresh command, the DRAM rank is guaranteed to be idle for a minimum of refresh cycle time, tRC. At least during this idle time before the refresh cycle time tRC expires, the memory controller knows that no read or write commands are issued to the DRAM rank. For example, DDR4 allows up to nine refresh commands to be bursted (e.g., in 1× mode). Some programmable number of consecutive refresh commands can be used to initiate SSD background tasks.

According to one embodiment, a power-down entry command can initiate background SSD operations. The power-down entry command can indicate that the host memory controller 160 is idle. FIG. 5 shows an example for initiating SSD background tasks based on a power-down entry command, according to one embodiment. A power-down exit can be issued tPD after a power-down entry. At least during this idle time before the power down time tPD expires, the memory controller knows that no read or write commands are issued to the DRAM rank. The main controller 150 can initiate background SSD operations upon receiving the power-down entry command.

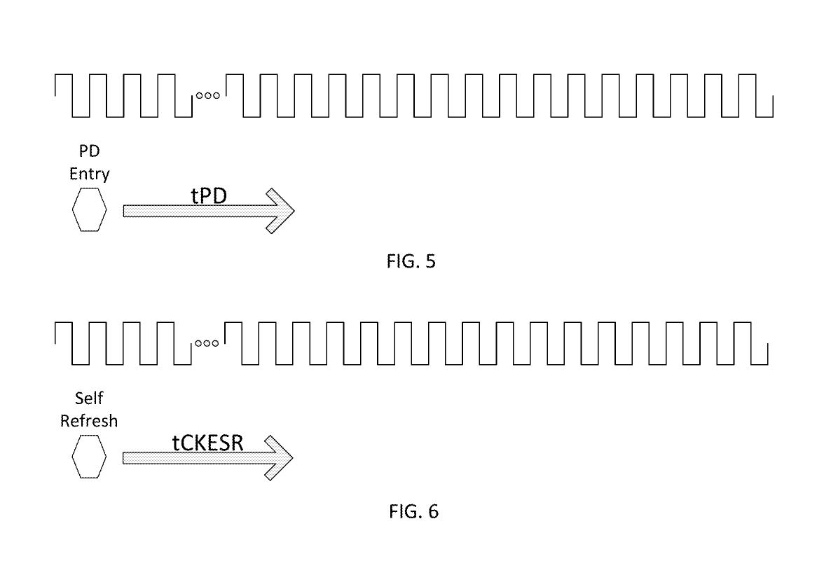

According to one embodiment, a self-refresh command can initiate background SSD operations. The self-refresh command can indicate that the host memory controller 160 is idle. FIG. 6 shows an example for initiating SSD background tasks based on a self-refresh entry command, according to one embodiment. A self-refresh exit can be issued tCKESR after a self-refresh entry. At least during this idle time before the self-refresh exit time tCKESR expires, the memory controller knows that no read or write commands are issued to the DRAM rank. The SoC can be programmed to initiate background SSD operations upon receiving the self-refresh entry command.

According to one embodiment, a memory module includes a solid-state drive (SSD) and a memory controller. The memory controller can be configured to initiate background tasks of the SSD based on information received from a host memory controller via a synchronous memory channel. The SSD can include a flash memory and the synchronous memory channel can be a synchronous dynamic random-access memory (DRAM) channel. The memory module can further include a DRAM memory, and the memory controller can include a DRAM memory controller for controlling the DRAM memory and a flash memory controller for controlling the flash memory.

The background tasks of the SSD can include garbage collection, wear leveling, and erase block preparation. The SSD background tasks can be automatically initiated in a power-down mode, a power-saving mode, a self-refresh, or an auto-refresh mode of the memory module.

The memory controller can determine a period of inactivity when a clock enable signal received from the host memory controller is low or when no memory commands are received from the host memory controller. The information received from the host memory controller can include a precharge all command. The information received from the host memory controller can include refresh commands, and the memory controller can include a counter configured to initiate the background tasks based on a programmable threshold of refresh commands. The information received from the host memory controller can include a power-down entry command. The information received from the host memory controller can include a self-refresh entry command.

According to one embodiment, a method includes: receiving memory commands from a host memory controller via a synchronous memory channel; determining a device state of a memory module including a solid-state drive (SSD) based on the memory commands; and initiating background tasks of the SSD based on the device state. The SSD can include a flash memory and the synchronous memory channel can be a synchronous dynamic random-access memory (DRAM) channel. The memory module can further include a DRAM memory, and the memory controller can include a DRAM memory controller and a flash memory controller.

The background tasks of the SSD can include garbage collection, wear leveling, and erase block preparation. The SSD background tasks can be automatically initiated in a power-down mode, a power-saving mode, a self-refresh, or an auto-refresh mode of the memory module.

The memory controller can determine a period of inactivity when a clock enable signal received from the host memory controller is low or when no memory commands are received from the host memory controller. The information received from the host memory controller can include a precharge all command. The information received from the host memory controller can include refresh commands, and the memory controller can include a counter configured to initiate the background tasks based on a programmable threshold of refresh commands. The information received from the host memory controller can include a power-down entry command. The information received from the host memory controller can include a self-refresh entry command.

The above example embodiments have been described hereinabove to illustrate various embodiments of implementing a system and method for dynamically scheduling memory operations for non-volatile memory. Various modifications and departures from the disclosed example embodiments will occur to those having ordinary skill in the art. The subject matter that is intended to be within the scope of the present disclosure is set forth in the following claims.

What is claimed is:

1. A memory module comprising:
a solid-state drive (SSD);
a memory controller configured to initiate background tasks of the SSD based on information received from a host memory controller via a synchronous memory channel.

2. The memory module of claim 1, wherein the SSD includes a flash memory, and the synchronous memory channel is a synchronous dynamic random-access memory (DRAM) channel.

3. The memory module of claim 2 further comprising a DRAM memory, wherein the memory controller includes a DRAM memory controller and a flash memory controller.

4. The memory module of claim 1, wherein the background tasks of the SSD include garbage collection, wear leveling, and erase block preparation.

5. The memory module of claim 1, wherein the SSD background tasks are automatically initiated in a power-down mode, a power-saving mode, a self-refresh, or an auto-refresh mode of the memory module.

6. The memory module of claim 1, wherein the memory controller determines a period of inactivity when a clock enable signal received from the host memory controller is low or when no memory commands are received from the host memory controller.

7. The memory module of claim 1, wherein the information received from the host memory controller includes a precharge all command.

8. The memory module of claim 1, wherein the information received from the host memory controller includes refresh commands, and wherein the memory controller includes a counter configured to initiate the background tasks based on a programmable threshold of refresh commands.

9. The memory module of claim 1, wherein the information received from the host memory controller includes a power-down entry command.

10. The memory module of claim 1, wherein the information received from the host memory controller includes a self-refresh entry command.

11. A method comprising:
receiving memory commands from a host memory controller via a synchronous memory channel;
determining a device state of a memory module including a solid-state drive (SSD) based on the memory commands; and
initiating background tasks of the SSD based on the device state.

12. The method of claim 11, wherein the SSD includes a flash memory and the synchronous memory channel is a synchronous dynamic random-access memory (DRAM) channel.

13. The method of claim 12, wherein the memory module further comprises a DRAM memory, and wherein the memory controller includes a DRAM memory controller and a flash memory controller.

14. The method of claim 11, wherein the background tasks of the SSD include garbage collection, wear leveling, and erase block preparation.

15. The method of claim 11, wherein the SSD background tasks are automatically initiated in a power-down mode, a power-saving mode, a self-refresh, or an auto-refresh mode of the memory module.

16. The method of claim 11, further comprising determining a period of inactivity when a clock enable signal received from the host memory controller is low or when no memory commands are received from the host memory controller.

17. The method of claim 11, wherein the information received from the host memory controller includes a precharge all command.

18. The method of claim 11, wherein the information received from the host memory controller includes refresh commands, and wherein the memory controller includes a counter configured to initiate the background tasks based on a programmable threshold of refresh commands.

19. The method of claim 11, wherein the information received from the host memory controller includes a power-down entry command.

20. The method of claim 11, wherein the information received from the host memory controller includes a self-refresh entry command.
